(19) United States
(12) Patent Application Publication
(10) Pub. No.: US 2009/0286692 A1
(43) Pub. Date: Nov. 19, 2009

(54) Cartridge and Method for Sample Analysis

(76) Inventors: Norman R. Wainwright, Johns Island, SC (US); Andrew Steele, Takoma Park, MD (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/424,190

(22) Filed: Apr. 15, 2009

Related U.S. Application Data
(60) Provisional application No. 61/045,016, filed on Apr. 15, 2008.

(51) Int. Cl. C40B 30/04; C40B 60/12

(52) U.S. Cl. 506/9; 506/39

(57) ABSTRACT

The invention provides a cartridge containing an addressable array for detecting the presence of one or more target analytes in a fluid sample. The cartridge comprises (i) a housing defining a sample inlet, an optical cell, an outlet, a first conduit in fluidic communication with the sample inlet and the optical cell, and a second conduit in fluidic communication with the outlet and the optical cell, (ii) an addressable array disposed within the optical cell; and (iii) a reagent dried upon a fluid contacting surface of at least one of the sample inlet and the first conduit, such that, when a fluid sample is applied to the fluid inlet, the fluid sample mobilizes and transports the reagent to the optical cell. The invention also provides a method of detecting one or more analytes in a fluid sample of interest.

### CROSS-REFERENCE TO RELATED APPLICATIONS

This application claims priority to and the benefit of U.S. Provisional Patent Application Ser. No. 61/045,016, filed Apr. 15, 2008, entitled “Cartridge and Method for Sample Analysis,” the entire disclosure of which is incorporated by reference herein.

### STATEMENT REGARDING FEDERALLY SPONSORED RESEARCH OR DEVELOPMENT

The research described in this application was sponsored, in part, by the National Aeronautics and Space Administration (NASA) under Grant No. NNG04GF49G. The United States Government has certain rights in the invention.

### FIELD OF THE INVENTION

The invention relates generally to apparatus and methods for detecting the presence of an analyte in a fluid sample. More specifically, the invention relates to a cartridge containing an array for simultaneously detecting the presence of one or more analytes in a fluid sample, and to methods of using such a cartridge.

### BACKGROUND OF THE INVENTION

A variety of systems have been developed for detecting the presence of analyte in a fluid sample, for example, a body fluid sample, water, or waste effluent. Cartridge-based systems, such as those described in U.S. Pat. Nos. 5,591,645 and 5,656,503, have been developed for the detection of a single analyte, for example, a hormone, in a fluid sample. Other devices have been developed that simultaneously detect the presence of multiple analytes in a fluid sample. For example, U.S. Pat. No. 6,406,921 describes protein-based arrays for use in high-throughput drug screening and clinical diagnostics. Similarly, U.S. Pat. Nos. 5,837,832, 6,045,996, and 6,052,270 describe nucleic acid-based arrays for use in nucleic acid-based hybridization assays.

Over the years, efforts have been made to produce reliable, automated array-based diagnostic systems. For example, U.S. Patent Application Publication No. 2004/0141880 A1 describes a sample processing system to address certain problems believed to be associated with cartridge-based assay, for example, the introduction of air bubbles that prevent the entire active surface of a microarray from being accessible to the liquid sample being interrogated, and clogging, for example, valve clogging, that can occur when the fluid samples contain high concentrations of salt. U.S. Patent Application Publication No. 2004/0141880 A1 describes a system comprising a cartridge and a pipettor. The cartridge comprises a chamber with an inlet and an outlet, and contains microarray with an active surface accessible to liquid contained in the chamber. The cartridge further comprises an inlet port configured and dimensioned to form an air tight connection with a pipette when the pipette tip is inserted into the inlet. The device, however, requires the user to perform one or more sample preparation steps before introducing the fluid sample into the cartridge.

Accordingly, there is still a need for systems that can quickly, reliably, and simultaneously detect the presence of one or more analytes in a fluid sample, where the results can be achieved with a minimum number of sample manipulation steps prior to detection.

### SUMMARY OF THE INVENTION

In one aspect, the invention provides a cartridge for simultaneously detecting presence of a plurality of different analytes in a fluid sample. The cartridge comprises: (i) a housing defining a sample inlet, an optical cell, an outlet, a first conduit in fluidic communication with the sample inlet and the optical cell, and a second conduit in fluidic communication with the outlet and the optical cell; (ii) an addressable array disposed within the optical cell; and (iii) a reagent dried upon a fluid contacting surface of at least one of the sample inlet and the first conduit. When a fluid sample to be tested is applied to the fluid inlet, the fluid sample mobilizes and transports the reagent to the optical cell where it is facilitates detection of an analyte if present in the fluid sample.

In certain embodiments, the reagent comprises a detectable label, which can directly or indirectly label an analyte. In the direct approach, the dried reagent optionally comprises a chemical moiety capable of chemically coupling the detectable label to one or more components, for example, target analyte, in the fluid sample. In the direct approach, a number of different analytes can be labeled with the same reagent. In the indirect approach, the dried reagent comprises a binder for the analyte that binds the analyte conjugated with a detectable label. It is understood that the binder for the analyte can be, for example, a protein or a nucleic acid. Furthermore, it is understood that the binder for the analyte can bind directly or indirectly to the analyte. In a first approach, a binder, for example, an antibody or another binding moiety, conjugated with a detectable label binds to the target analyte. In the second approach, a binder, for example, a first antibody or a first binding moiety, conjugated with a detectable label, binds a second antibody or second binding moiety that binds to the target analyte.

Depending upon the binder for the analyte, the dried reagent may label just one analyte or multiple, different analytes. Accordingly, when a binder binds a single analyte, it may be necessary to use multiple different labeled reagents, wherein each reagent comprises a label conjugated to a different binder for binding a different analyte of interest.

Upon operation of the device, the fluid sample is applied to the sample inlet. The fluid sample then moves towards the optical cell, which in the process of doing so contacts the dried regent causing the reagent to be mobilized and transported to the optical cell. During transport to the optical cell, the analyte, if present, becomes labeled (directly or indirectly) with a detectable label, and the labeled analyte, again if present, passes into the optical cell containing the addressable array. The array comprises a plurality of spaced apart regions, wherein each region comprises an immobilized binder for an analyte. As a result, because each region of the array is capable of binding a different analyte, the array can simultaneously detect the presence of multiple, different analytes in the fluid sample. Furthermore, depending upon the sensitivity and the dynamic range for the system, each region can comprise a plurality of the same binders for analyte so that a plurality of the same analytes are captured by each region of the microarray. As a result, the dynamic range of the device can be modulated so that the signal produced in each region corresponds to the concentration of analyte in the test sample.

In another aspect, the invention provides a method of detecting the presence of one or more target analytes in a fluid sample. The method comprising the steps of: (a) applying a fluid sample to the sample inlet of the cartridge described herein; and (b) detecting the presence of a signal produced at the addressable array. The presence of signal at a particular region of the array is indicative of the presence of a preselected analyte in the fluid sample. Furthermore, once the system has been calibrated, the amount of the signal at a particular region of the array can also be indicative of the amount of the concentration or amount of the analyte in the fluid sample.

The foregoing and other objects, features and advantages of the present invention will be made more apparent from the following figures and detailed description of preferred embodiments of the invention.

### BRIEF DESCRIPTION OF THE DRAWINGS

The objects and features of the invention may be better understood by reference to the drawings described below, in which:

FIG. 1 is a schematic top perspective view of a cartridge manufactured in accordance with one embodiment of the invention;

FIG. 2 is a schematic bottom perspective view of the cartridge of FIG. 1;

FIG. 3 is an exploded schematic top perspective view of the cartridge of FIG. 1;

FIG. 4 is an exploded schematic bottom perspective view of the cartridge of FIG. 1;

FIG. 5 is a cross-sectional view of the conduit of the cartridge of FIG. 1;

FIG. 6 is a schematic top view of a preloaded cartridge in accordance with one embodiment of the invention;

FIG. 7 is a schematic top perspective view of a bottom portion of an exemplary cartridge manufactured in accordance with one embodiment of the invention;

FIGS. 8A-8C are schematic top sectional (FIG. 8A), cross-sectional (FIG. 8B), and bottom (FIG. 8C) views of a cartridge manufactured in accordance with one embodiment of the invention;

FIG. 9 is a schematic top perspective view of a cartridge in accordance with one embodiment of the invention inserted into a testing device; and

FIG. 10 is a flowchart depicting steps of a process used to test for the presence of an analyte in a fluid sample.

In the drawings, which are not necessarily drawn to scale, like characters refer to the same or similar parts throughout the figures.

### DETAILED DESCRIPTION

The invention relates to a system capable of simultaneously detecting the presence of a plurality of different analytes in a sample. The system uses a cartridge and, depending upon the detectable labels included in the cartridge, a suitable detection system. The cartridge comprises a housing containing an addressable array, wherein each region of the array is capable of capturing one or more analytes in the sample, and at least one reagent that facilitates detection of the analyte when immobilized by the array. The invention provides a method, using such a cartridge, for simultaneously detecting the presence of multiple analytes in the fluid sample.

In one aspect, the cartridge comprises: (i) a housing defining a sample inlet, an optical cell, an outlet, a first conduit in fluidic communication with the sample inlet and the optical cell, and a second conduit in fluidic communication with the outlet and the optical cell; (ii) an addressable array disposed within the optical cell; and (iii) a reagent dried upon a fluid contacting surface of at least one of the sample inlet and the first conduit. The cartridge preferably has a planar or substantially planar configuration when positioned on a horizontal surface so that the microarray is substantially horizontal during operation of the cartridge.

Upon operation of the device, the sample of interest is applied to the inlet port of the cartridge. The fluid sample then traverses the first conduit as it passes to the optical cell. The dried reagent is applied to a fluid contacting surface of the fluid inlet or the first conduit. Accordingly, as the fluid sample moves to the optical cell it contacts the dried reagent and dissolves, resuspends or otherwise resolubilizes the dried reagent. The dried reagent, when dried on the fluid contacting surface, can be dried together with other reagents, for example, sugars, salts, and detergents, to facilitate dissolution or resuspension of the dried reagent. Once dissolved or resuspended in the fluid sample, the reagent, for example, the detectable label, can bind (either directly or indirectly) to analyte, if present in the fluid sample. The analyte, if present in the sample, then is captured by an immobilized binder for the analyte disposed within a particular region of the array. The captured analyte can then be detected using a detection system capable of detecting the label, and the identity of the analyte can be identified by knowing what binder for analyte was immobilized in a particular region of the addressable array.

### 1. Cartridge Considerations

The actual cartridge will vary depending upon the various analytes to be tested, the assay format, the reagents used in the assays (for example, the reagents used to bind and/or detect the analytes of interest), and the detection system used to detect binding events that occur at the array.

a. Detectable Labels and Detection Systems

Depending upon the assay format chosen, the reagent comprises a detectable label that binds (directly or indirectly) an analyte. The binding can be covalent or non-covalent. It is understood that a variety of different detectable labels can be used in the practice of the invention.

In certain embodiments, the label can be a colored particle, for example, a gold sol particle or a colored latex particle. The aggregation of colored particles in a region of the array can produce a signal visible by the unaided eye. Alternatively, the signal can be detected and/or quantitated by a suitable detection system, for example, a camera or a charge-coupled device (CCD) detector.

Alternatively, the detectable labels can include, radiolabels, magnetic and paramagnetic labels, fluorescent labels, chemiluminescent labels, optical labels, enzymatic labels, for example, enzymatic labels that produce color in the presence of a chromogenic substrate, and other physical or chemical labels known in the art. Depending upon the choice of the detectable label, the signal can be detected with the appropriate detection system, for example, an optical detector, for example, a camera or CCD detector, a spectrophotometer, fluorimeter, radiation detector.

Exemplary labels include, for example, fluorescent labels, such as fluorescein, rhodamine, BODIPY, cyanine dyes, Alexa dyes, fluorescent dye phosphoramidites, beads, chemiluininescent compounds, colloidal particles, and the like. Exemplary fluorescent labels are known in the art, including fluorescein isothiocyanate (FITC); rhodamine and rhodamine derivatives; Texas Red; phycoerythrin; allophycocyanin; 6-carboxyfluorescein (6-FAM); 2′,7′-dimethoxy-41,51 -dichloro carboxyfluorescein (JOE); 6-carboxy-X-rhodamine (ROX); 6-carboxy-21,41,71,4,7-hexachlorofluorescein (HEX); 5-carboxyfluorescein (5-FAM); N,N,N 1,N′-tetramethyl carboxyrhodamine (TAMRA); sulfonated rhodamine; Cy3, Cy5, Cy5.5, and Cy7, each of which are available from GE Healthcare; VivoTag-680, VivoTag-S680, VivoTag-S750, each of which are available from VisEn Medical; AlexaFluor532, AlexaFluor660, AlexaFluor680, AlexaFluor700, AlexaFluor750, and Alexa Fluor790, each of which are available from Invitrogen; Dy677, Dy676, Dy682, Dy752, Dy780, each of which are available from Dyonics; DyLight547 and DyLight647, each of which are available from Pierce; HiLyte Fluor 647, HiLyte Fluor 680, and HiLyte Fluor 750, each of which are available from AnaSpec; IRDye800CW, IRDye 800RS, and IRDye 700DX, each of which are available from Li-Cor; and ADS780WS, ADS830WS, and ADS832WS, each of which are available from American Dye Source.

Exemplary enzymatic labels include, for example, alkaline phosphatase and horseradish peroxidase, as well as various proteolytic enzymes, which are then used to produce a detectable signal when incubated with the appropriate chromogenic substrate. Exemplary radiolabels, include, for example, ³⁵S, ³²P, ³H, ¹²⁵I, and the like.

Another useful detectable label includes water-soluble quantum dots, or so-called “functionalized nanocrystals” or “semiconductor nanocrystals” as described in U.S. Pat. No. 6,114,038. Generally, quantum dots can be prepared which result in relative monodispersity (e.g., the diameter of the core varying approximately less than 10% between quantum dots in the preparation) as previously described (see, e.g., Bawendi et al., 1993, J. Am. Chem. Soc. 115:8706). Examples of quantum dots are known in the art to have a core selected from the group consisting of CdSe, CdS, and CdTe (collectively referred to as “CdX”) (see, e.g., Norris et al., 1996, Physical Review B. 53:16338-16346; Nirmal et al., 1996, Nature 383:802-804; Empedocles et al, 1996, Physical Review Letters 77:3873-3876; Murray et al., 1996, Science 270: 1355-1338; Effros et al, 1996, Physical Review B. 54:4843-4856; Sacra et al., 1996, J. Chem. Phys. 103:5236-5245; Murakoshi et al., 1998, J. Colloid Interface Sci. 203:225-228; Optical Materials and Engineering News, 1995, Vol. 5, No. 12; and Murray et al., 1993, J. Am. Chem. Soc. 115:8706-8714).

CdX quantum dots have been passivated with an inorganic coating (“shell”) uniformly deposited thereon. Passivating the surface of the core quantum dot can result in an increase in the quantum yield of the luminescence emission, depending on the nature of the inorganic coating. The shell which is used to passivate the quantum dot can comprise a compound defined by the formula Y-Z, wherein Y is Cd or Zn, and Z is S, or Se. Quantum dots having a CdX core and a YZ shell have been described in the art (see, e.g., Danek et al., 1996, Chem. Mater. 8:173-179; Dabbousi et al., 1997, J. Phys. Chem. B 101:9463; Rodriguez-Viejo et al., 1997, Appl. Phys. Lett. 70:2132-2134; Peng et al, 1997, J. Am. Chem. Soc. 119:7019-7029; 1996, Phys. Review B. 53:16338-16346).

In the direct labeling approach, the dried reagent optionally comprises a chemical moiety capable of chemically coupling the detectable label to reactive groups, for example, a amine, carboxyl group, hydroxyl, or sulfhydryl group, present in molecules, for example, analytes of interest, in the fluid sample. The linkage can be, for example, via thioether bonds, disulfide bonds, amide bonds, carbamate bonds, urea linkages, ester bonds, carbonate bonds, ether bonds, hydrazone linkages, Schiff-base linkages. Exemplary chemically moieties include, for example, a succinimidyl ester moiety (for example, an amine reactive N-hydroxysuccinimide (NHS) ester), tetrafluorophenyl ester, pentafluorophenyl ester, para-nitrophenyl ester, benzotriazolyl ester, aldehyde, epoxy, thiol, and an iodoacetyl group. In the direct approach, a number of analytes can be labeled with the same reagent provided that they contain one or more reactive groups that react with the chemical moiety present in the dried reagent.

In the indirect approach, the dried reagent comprises a binder for the analyte conjugated, for example, covalently or non-covalently, with a detectable label. The binder for analyte can be any molecule that binds, preferably binds specifically, an analyte of interest, and can be any member of a binding pair, for example, a protein-protein binding pair, a nucleic acid-nucleic acid binding pair, a protein-nucleic acid binding pair, or a protein-sugar binding pair.

b. Binding Moieties

Again, depending upon the assay format, the cartridges of the invention can use one, two or more binders for analyte. For example, certain assay formats use immobilized binders for analyte disposed in the addressable array. Certain other embodiments, for example, in the indirect labeling approach also use a binder for analyte conjugated with a detectable moiety.

The binder can be any molecule that constitutes one half of a binding pair, and can include, for example, a protein (which includes peptides), a nucleic acid (including double stranded or single stranded nucleic acids that are linear or circular), a peptide nucleic acid (PNAs), a carbohydrate, a glycoproteins, or small molecule. Exemplary binding proteins include, antibodies (such as monoclonal and polyclonal antibodies, and antigen binding fragments thereof, and biosynthetic antibody binding sites), scaffolded proteins (such as, fibronectins, thioredoxins, avian pancreatic polypeptide (aPP), and Top7), lectins, avidin or streptavidin that binds biotin, enzymes that bind a particular substrates, receptors that bind a particular ligand. It is understood, that when the analyte is an binding protein, for example, an antibody, the binding partner immobilized in a region of the array can be any molecule that is bound by the binding protein, for example, a molecule defining an epitope bound by the antigen binding fragment of the antibody to be detected. Exemplary nucleic acids include, nucleic acids that hybridize to complementary sequences, for example, when the target is a nucleic acid, nucleic acids that bind to proteins (for example, DNA- or RNA-binding proteins), aptamers, and allosteric ribozymes.

Depending upon the binder for analyte, the dried reagent may label just one or a plurality of different analytes. When a binder binds a single analyte, it may be necessary to use multiple different labeled reagents, wherein each reagent comprises a different binder for binding a different analyte of interest.

In one preferred embodiment, the binder for analyte is an antibody or an antibody-like molecule (collectively an “antibody”). An antibody useful as a capture agent or binding moiety can be a full length antibody or a fragment thereof, which includes an “antigen-binding fragment” of an antibody. The term “antigen-binding fragment,” as used herein, refers to one or more fragments of an antibody that retain the ability to specifically bind an antigen. Examples of antigen-binding fragments include (i) an Fab fragment, a monovalent fragment comprising a single antigen binding site, (ii) a V_{L}, domain optionally including a C_{L} domain, or a V_{H}, domain optionally including a C_{H}, domain; (iii) an F(ab′)₂ fragment, a bivalent fragment comprising two Fab fragments linked by a disulfide bridge at the hinge region; (iv) an Fv fragment comprising the V_{L} and V_{H} domains of a single arm of an antibody linked together by a peptide linker (see, e.g., Bird et al. (1988) Science 242:423-426; and Huston et al. (1988) Proc. Natl. Acad. Sci. USA 85:5879-5883; and Osbourn et al. 1998, Nature Biotechnology 16: 778), and (v) an isolated complementarity determining region (CDR). Diabodies are bivalent, bispecific antibodies in which V_{H} and V_{L} domains are expressed on a single polypeptide chain, but using a linker that is too short to allow for pairing between the two domains on the same chain, thereby forcing the domains to pair with complementary domains of another chain and creating two antigen binding sites (see, e.g., Holliger, P., et al (1993) Proc. Natl. Acad. Sci. USA 90:6444-6448; Poljak, R. J., et al. (1994) Structure 2:1121-1 123). Antibodies useful in the practice of the invention can be made and purified using techniques known in the art, and often can be purchased from commercial vendors.

In another embodiment, the binder for analyte is an aptamer, e.g., RNA aptamer or DNA aptamer, which includes single-stranded oligonucleotides that specifically bind a target molecule. Aptamers can be selected using an in vitro evolution protocol called systematic evolution of ligands by exponential enrichment or SELEX (see, for example,. Brody et al. (1999) Mol. Diagn. 4:381 388). Aptamers bind tightly and specifically to target molecules and can have a K_{d} (equilibrium dissociation constant) in the range of 1 pM to 1 nM. Using the SELEX approach, hundreds to thousands of aptamers can be made in an economically feasible fashion.

In another embodiment, the binder for analyte is an allosteric ribozyme, which includes single-stranded oligonucleotides that perform catalysis when triggered with a variety of effectors, e.g., nucleotides, second messengers, enzyme cofactors, pharmaceutical agents, proteins, and oligonucleotides. Allosteric ribozymes and methods for preparing them are described in, for example, Seetharaman et al. (2001) Nature Biotechnol. 19: 336 341. According to Seetharaman et al, a prototype biosensor array has been assembled from engineered RNA molecular switches that undergo ribozyme-mediated self-cleavage when triggered by specific effectors. Each type of switch is prepared with a 5′-thiotriphosphate moiety that permits immobilization on gold to form individually addressable pixels. The ribozymes comprising each pixel become active only when presented with their corresponding effector, such that each type of switch serves as a specific analyte sensor. An addressed array created with seven different RNA switches was used to report the status of targets in complex mixtures containing metal ion, enzyme cofactor, metabolite, and drug analytes.

c. Array Considerations

The array comprises a plurality of spaced apart regions, wherein each region comprises an immobilized binder for an analyte. It is understood that, depending upon the assay format, the same types of binder for analyte described above can also be immobilized in each region of the array. Methods and reagents for immobilizing the binders to produce an array are described, for example, in U.S. Pat. Nos. 5,744,305, 5,837,832, 6,054,270, 6,045,996 and 6,406,921. Because each region of the array is capable of binding a different analyte, the array can simultaneously detect the presence of multiple, different analytes in the sample. For example, a first binder for analyte immobilized in a first region binds a first preselected analyte and a second binder for analyte immobilized in a second region binds a second, different preselected analyte. Under certain circumstances, the array can comprise from about 10, 20, 30, 40, 50, 60, 70, 80, 90, 100 different regions per mm², each of which is capable (via the binder for analyte immobilized in each region) of binding a separate analyte. Furthermore, depending upon the sensitivity of the system, each region can comprise a plurality of binders for analyte (for example, from about 10 to about 10,000 femtograms of the same binder) so that a plurality of the same analyte molecules are captured by each region of the microarray. As a result, assuming that the system is being used within its dynamic range, the signal produced in reach region increases as a function of analyte concentration.

In certain assay configurations, the microarray is disposed directly onto the base of the optical cell, i.e., each binder for analyte is immobilized on surface of the optical cell. In other assay configurations, the microarray can be disposed on a solid support, for example, a glass or plastic support member, which is placed on or attached to the base of the optical cell.
1. Immobilization Considerations

The variables in immobilization of particular binding moieties, for example, proteins, include both the coupling reagent and the nature of the surface being coupled to. Ideally, the immobilization method should be reproducible, applicable to binders of different properties (size, hydrophilic, hydrophobic), amenable to high throughput and automation, and compatible with retention of fully functional protein activity. Orientation of the surface-bound binder can be an important factor for capture arrays to maximize binding.

The properties of a good array support surface are that it should be chemically stable before and after the coupling procedures, allow good spot morphology, display minimal nonspecific binding, not contribute a background in detection systems, and be compatible with different detection systems.

Both covalent and noncovalent methods for immobilizing the binding moieties on solid support can be used. Passive adsorption to surfaces, although simple, allows little quantitative or orientational control, it may or may not alter the functional properties of the binding moiety, and the resulting binding reproducibility and efficiency can be variable. Covalent coupling methods provide a stable linkage, can be applied to a range of binding moieties and can be reproducible. However, orientation may be variable.

Several immobilization chemistries have been described for fabrication of arrays, for example, protein arrays. Substrates for covalent attachment include glass slides pre-coated with reagents, for example, epoxy modifications, and amine- or aldehyde-containing silane reagents [Telechem]. In the Versalinx™ system [Prolinx], reversible covalent coupling is achieved by interaction between the protein derivatized with phenyldiboronic acid, and salicylhydroxamic acid immobilized on the support surface. This also has low background binding and low intrinsic fluorescence and allows the immobilized proteins to retain function. Noncovalent binding of unmodified protein occurs within porous structures such as HydroGel™ [PerkinElmer], based on a 3-dimensional polyacrylamide gel—this substrate is reported to give a particularly low background on glass microarrays, with a high capacity and retention of protein function. Widely used biological capture methods are through biotin/streptavidin (avidin) or hexahistidine/Ni interactions, having modified the protein appropriately. For example, biotin may be conjugated to a poly-lysine backbone immobilized on a surface such as titanium dioxide [Zyomyx] or tantalum pentoxide [Zeptosens].

U.S. Pat. No. 4,282,287 describes a method for modifying a polymer surface through the successive application of multiple layers of biotin, avidin, and extenders. U.S. Pat. No. 4,562,157 describes a technique for attaching biochemical ligands to surfaces by attachment to a photochemically reactive arylazide. U.S. Pat. No. 4,681,870 describes a method for introducing free amino or carboxyl groups onto a silica matrix, in which the groups may subsequently be covalently linked to a protein in the presence of a carbodiimide. In addition, U.S. Pat. No. 4,762,881 describes a method for attaching a polypeptide chain to a solid substrate by incorporating a light-sensitive unnatural amino acid group into the polypeptide chain and exposing the product to low-energy ultraviolet light.

In certain embodiments, the surface of the support is chosen to possess, or is chemically derivatized to possess, at least one reactive chemical group that can be used for further attachment chemistry. There may be optional flexible adapter molecules interposed between the support and the binding moieties. In order to allow attachment by an adapter or directly by a binding moiety, the surface of the substrate may require preparation to create suitable reactive groups. Such reactive groups could include simple chemical moieties such as amino, hydroxyl, carboxyl, carboxylate, aldehyde, ester, amide, amine, nitrile, sulfonyl, phosphoryl, or similarly chemically reactive groups. Alternatively, reactive groups may comprise more complex moieties that include, but are not limited to, sulfo-N-hydroxysuccinimide, nitrilotriacetic acid, activated hydroxyl, haloacetyl (e.g., bromoacetyl, iodoacetyl), activated carboxyl, hydrazide, epoxy, aziridine, sulfonylchloride, trifluoromethyldiaziridine, pyridyldisulfide, N-acyl-imidazole, imidazolecarbamate, succinimidylcarbonate, arylazide, anhydride, diazoacetate, benzophenone, isothiocyanate, isocyanate, imidoester, fluorobenzene, biotin and avidin. Techniques for placing such reactive groups on a substrate by mechanical, physical, electrical or chemical means are well known in the art, such as described by U.S. Pat. No. 4,681,870.

Once the initial preparation of reactive groups on the substrate is completed (if necessary), adapter molecules optionally may be added to the surface of the substrate to make it suitable for further attachment chemistry. Substrate adapters can be selected from any suitable class of compounds and may comprise polymers or copolymers of organic acids, aldehydes, alcohols, thiols, amines and the like. For example, polymers or copolymers of hydroxy-, amino-, or di-carboxylic acids, such as glycolic acid, lactic acid, sebacic acid, or sarcosine may be employed. Alternatively, polymers or copolymers of saturated or unsaturated hydrocarbons such as ethylene glycol, propylene glycol, saccharides, and the like. Preferably, the substrate adapter should be of an appropriate length to allow the binding moiety, which is to be attached, to interact freely with molecules in a sample solution and to form effective binding. The substrate adapters may be either branched or unbranched, but this and other structural attributes of the adapter should not interfere stereochemically with relevant functions of the binding moieties.

Methods of coupling the binding moieties to the reactive end groups on the surface of the substrate or on the adapter include reactions that form linkage, such as, thioether bonds, disulfide bonds, amide bonds, carbamate bonds, urea linkages, ester bonds, carbonate bonds, ether bonds, hydrazone linkages, Schiff-base linkages, and noncovalent linkages mediated by, for example, ionic or hydrophobic interactions. The form of reaction will depend upon the available reactive groups on both the substrate/adapter and binding moiety.
2. Array Fabrication Considerations

Preferably, the immobilized binding moieties are arranged in an array on a solid support, such as a silicon-based chip or glass slide which is disposed on the optical cell or directly on a surface defined by the optical cell. One or more binding moieties designed to detect the presence (and optionally the concentration) of a given analyte is immobilized at each of a plurality of regions in the array. Thus, a signal at a particular region indicates the presence of a particular analyte in the sample, and the identity of the analyte is revealed by the position (for example, the x and y co-ordinates) of the region in the array.

In one embodiment, the array is high density, with a density over about 100, 1000, 1500, 2000, 3000, 4000, 5000 spots per cm², formed by attaching binding moieties onto a support surface which has been functionalized to create a high density of reactive groups or which has been functionalized by the addition of a high density of adapters bearing reactive groups. In another embodiment, the array comprises a relatively small number of binding moieties, e.g., 10, 20, 30 40, 50, 60, 70, 80 or 90 spots per cm², selected to detect in a sample various combinations of specific analytes.

Suitable substrate materials include, but are not limited to, glasses, ceramics, plastics, metals, alloys, carbon, papers, agarose, silica, quartz, cellulose, polyacrylamide, polyamide, and gelatin, as well as other polymer supports, other solid-material supports, or flexible membrane supports. Polymers that may be used as substrates include, but are not limited to: polystyrene; poly(tetra)fluoroethylene (PTFE); polyvinylidenedifluoride; polycarbonate; polymethylmethacrylate; polyvinylethylene; polyethyleneimine; polyoxymethylene (POM); polyvinylphenol; polylactides; polymethacrylimide (PMI); polyalkenesulfone (PAS); polypropylene; polyethylene; polyhydroxyethylmethacrylate (HEMA); polydimethylsiloxane; polyacrylamide; polyimide; and various block co-polymers. In one embodiment, the substrate is a plain glass slide coated with epoxy functionalities.

Arrays can be produced by a number of means, including “spotting,” wherein small amounts of the reactants are dispensed to particular positions on the surface of the substrate. Methods for spotting include, but are not limited to, microfluidics printing, microstamping (see, e.g., U.S. Pat. No. 5,515,131, U.S. Pat. No. 5,731,152), microcontact printing (see, e.g., PCT Publication WO 96/29629), inkjet head printing (Roda, A. et al. (2000) BioTechniques 28: 492 496, and Silzel, J. W. et al. (1998) Clin Chem 44: 2036 2043), microfluidic direct application (Rowe, C. A. et al. (1999) Anal Chem 71: 433-439 and Bernard, A. et al. (2001), Anal Chem 73: 8-12) and electrospray deposition (Morozov, V.N. et al (1999) Anal Chem 71: 1415-1420 and Moerman R. et al. (2001) Anal Chem 73: 2183-2189). Generally, the dispensing device includes calibrating means for controlling the amount of sample deposition, and may also include a structure for moving and positioning the sample in relation to the support surface. The volume of fluid to be dispensed per binding moiety in an array varies with the intended use of the array, and available equipment. The size of the resultant spots will vary, and in certain embodiments these spots are less than, for example, 20,000 μm in diameter, less than 2,000 μm in diameter, or in certain embodiments are about 150-200 μm in diameter (to yield about 1600 spots per square centimeter). Solutions of blocking agents may be applied to the arrays to prevent non-specific binding by reactive groups that have not bound to a binding moiety. Solutions of bovine serum albumin (BSA), casein, or nonfat milk, for example, can be used as blocking agents to reduce background binding in subsequent assays.

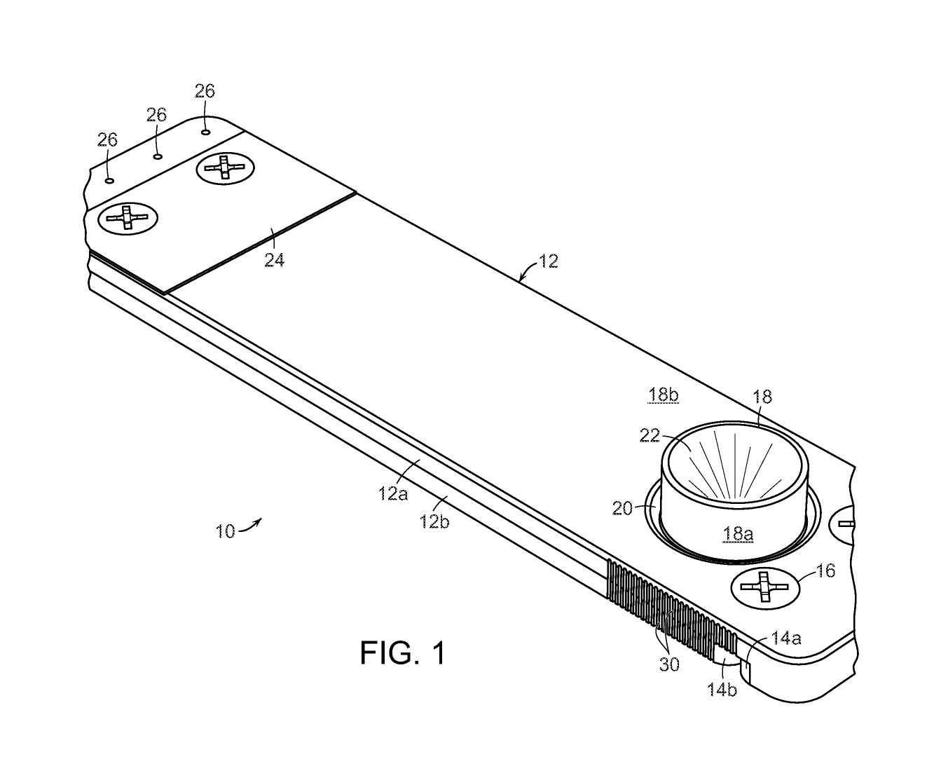

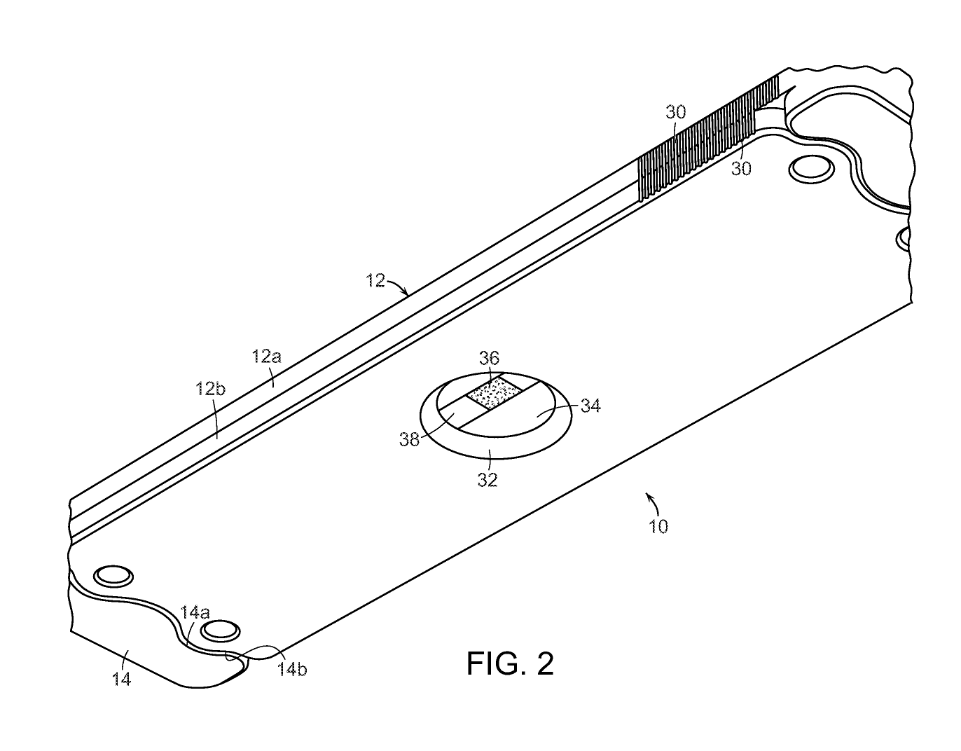

By way of example and in reference to FIGS. 1 and 2, exemplary cartridge 10 includes a housing 12 manufactured from of one or more sections. As depicted, housing 12 includes a top section 12a and a bottom section 12b that interfit with one another. In one embodiment, the outer dimensions of cartridge 10 are approximately 2.5 cm×10 cm×0.5 cm, however, it is understood that the cartridge can be other sizes depending, for example, upon the assay configuration, use, and particular detection system employed. The bottom section 12b has a contoured edge 14b adapted to mate with a corresponding contoured edge 14a of one or more protrusions 14, that extend from the top section 12a. Sections 12a, 12b of housing 12 are joined together, for example, by one or more screws 16, but may alternatively or additionally be joined by mechanical features such as pins, locking tabs, or friction or press fit connections, or by chemical or material bonds such as glues, epoxies, or friction welds or other joining techniques known in the art.

A sample well structure 18 is formed by or disposed on the top section 12a of the housing 12. For example, sample well structure 18 can be a removable structure or may be integrally molded with the top section 12a of the housing 12. The well structure 18 can have a generally cylindrical outer wall 18a and frustoconical interior wall 18b that slopes downward and radially inward from the top of the outer wall 18a, thus forming a conical well 22 having a fixed volume within the well structure 18. The volume of the well 22 is sized to contain a preselected amount of the fluid sample to be tested, and may be sized as desired for a particular application. In certain embodiments, well 22 may have a volume of up to about 10 μL, up to about 25 μL, up to about 50 μL, up to about 100 μL, up to about 200 μL, up to about 300 μL, up to about 400 μL, up to about 500 μL, up to about 750 μL, or up to about 1 mL.

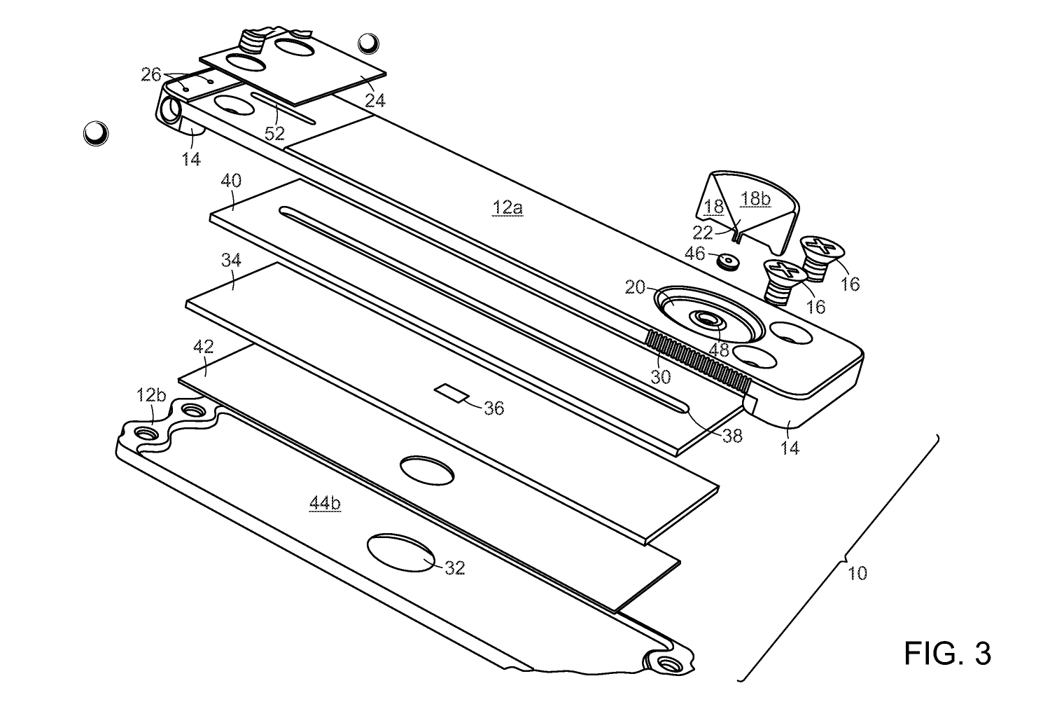

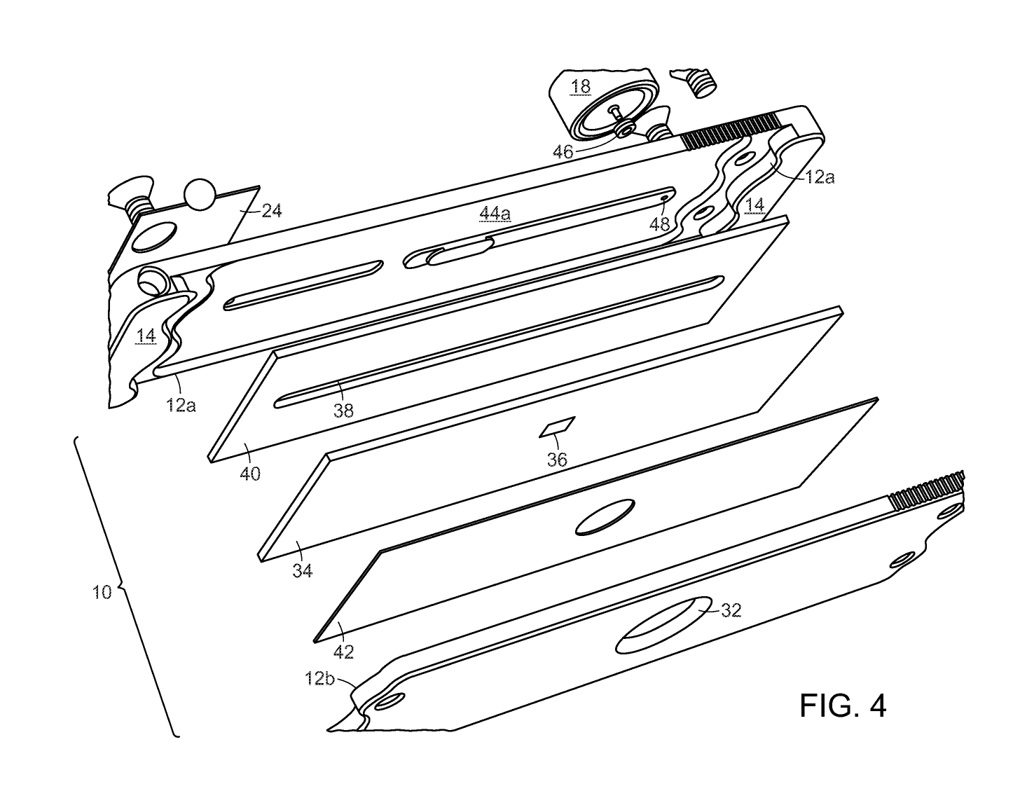

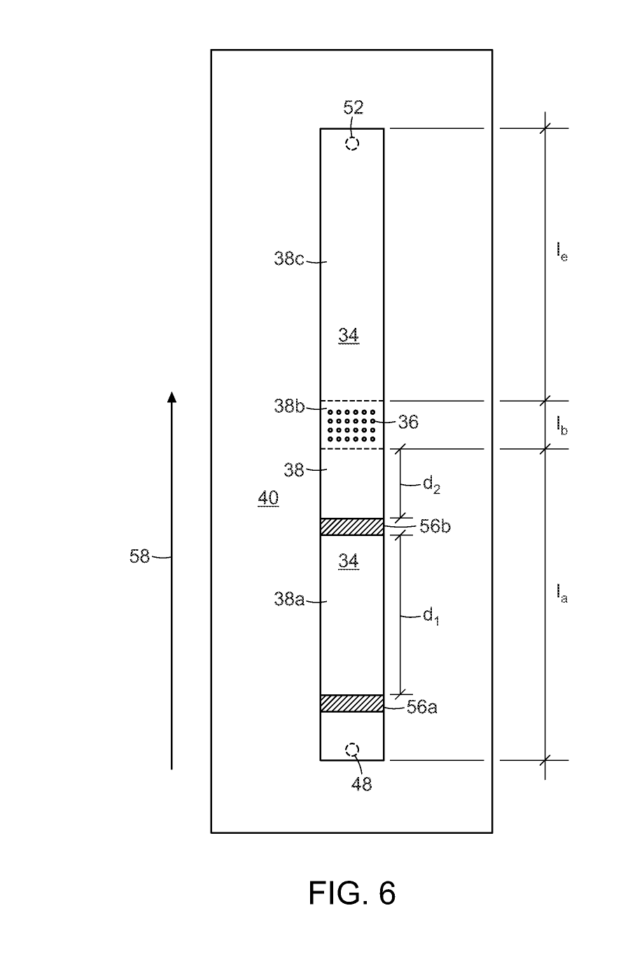

Well structure 18 can be set in a recess or depression 20 in the top section 12a having a complementary shape to the well structure 18. Depression 20 can center well structure 18 over a fluid inlet 48, as described in more detail below, and can capture overflow or spillage when filling the well structure 18. Also located on the top section 12a at the end opposite the fluid inlet 48 is a plurality of outlets 26. Outlets 26 are in fluidic communication with internal conduit 38 (see FIGS. 3 and 4) and internal chambers disposed within the housing 12. The region of internal conduit 38 that connects fluid inlet 48 and optical cell 36 is referred to as the first conduit (also referred to as the inlet conduit), and the region of internal conduit 38 that connects optical cell 36 and outlets 26 is referred to as the second conduit (also referred to as the waste conduit). As shown, the first and second conduits are both linear. It is understood that the first and second conduits can be defined by portions of the same structure (as shown in FIG. 3) or can be separate conduits having the same or different dimensions. In general, outlets 26 are sized and configured to engage with one or more vacuum ports contained within a detection device 28 (as shown in FIG. 6).

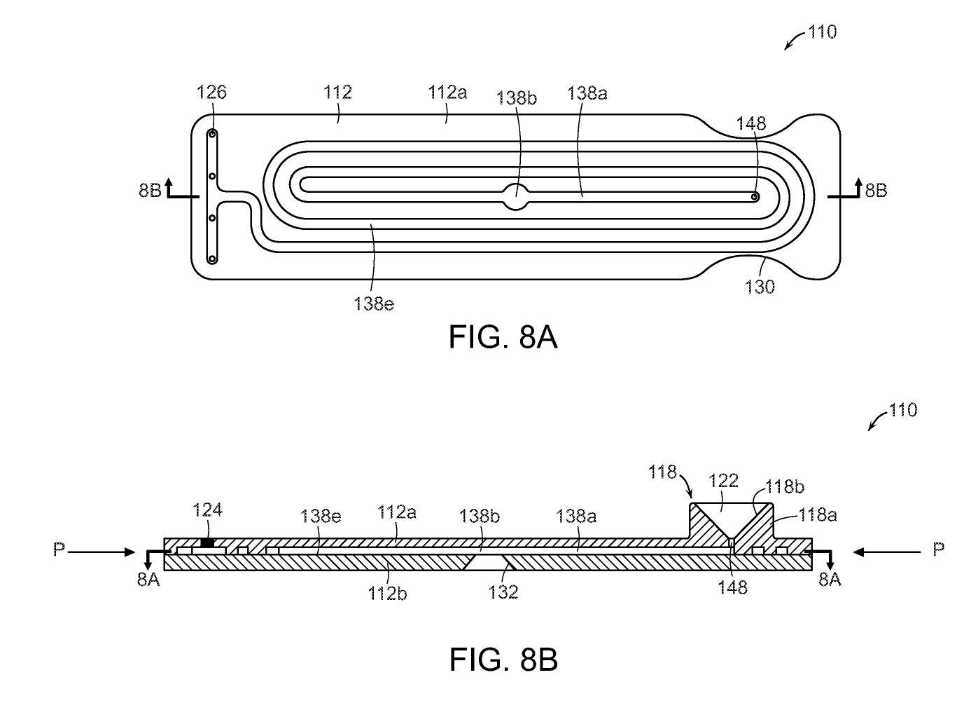

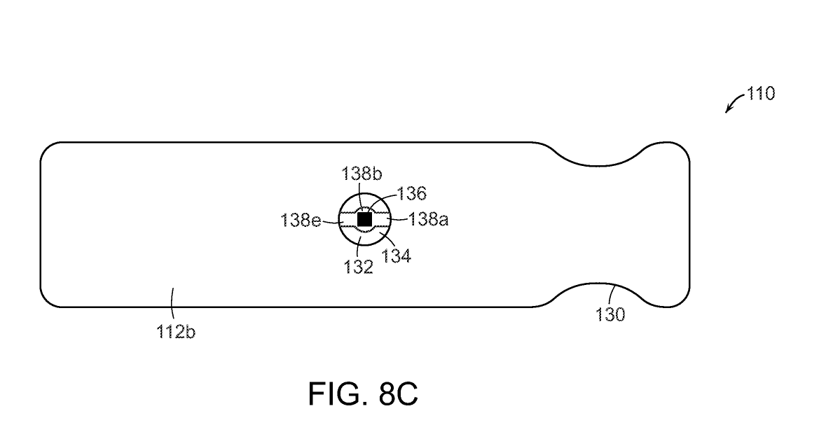

The outlets 26 may also be substantially planar with the fluid inlet 48 (during use of the device and cartridge). Other microarray cartridges utilize an array chamber having an outlet substantially higher than the inlet. These types of cartridges rely on the fluid introduced to the cartridge to force air from the array chamber; accordingly, it is desirable to have the array chamber outlet higher than the inlet, to prevent/reduce the formation of air bubbles within the fluid sample. In contrast, the cartridges described herein utilize an outlet substantially planar with an inlet (i.e., on substantially the same vertical elevation during use, as depicted, e.g., in FIG. 8B). Since the cartridge disclosed herein is placed under negative pressure to draw fluid through the array chamber, the outlet may be located at any vertical location relative to the inlet, since air bubble formation in a negative pressure environment is less of a concern. Cartridges having array chamber inlets and outlets (as well as sample inlets and pump outlets) on substantially the same plane are particularly advantageous, in that this substantially planar configuration reduces overall height and size of the cartridge. This allows for ease of insertion into the device, and allows the cartridge to be used in smaller devices.

Under certain conditions, draw-through type systems for moving fluids through assay cartridges under negative pressure may present advantages over push-through systems that move fluids under positive pressure. Draw-through systems, such as those described herein, can help reduce or eliminate bubble formation within the cartridge, since the cartridge is first nearly completely evacuated prior to movement of the fluid sample therein. Bubble formation can negatively impact the ability of analytes to bind to one or more of the immobilized binders disposed at regions of the addressable array and/or imaging the array. Additionally, vacuum systems utilizing pumps in general are more accurate than positive pressure systems that require the fluid sample to be moved through the cartridge by a user-manipulated pipette. Additionally, vacuum systems leave the sample inlet (in this case, the well 22) exposed during processing. This allows the user to easily access the inlet to introduce samples, reagents (if required), wash solutions, etc., without having to remove the pressure source (and potentially disrupt processing).

One potential drawback to a negative pressure system is the risk attendant with over-drawing the sample, such that the sample fluid is drawn directly into the suction pumps, which may damage the pumps and/or contaminate the device. To address this issue, an aperture window 24 can be defined by the cartridge. When inserted into a detection device 28, the window 24 is aligned with an optical detector that determines whether fluid sample is present in a monitor channel and about to contact outlets 26, which, depending upon the assay configuration, can be used to turn off the pump present in detection device 28. Textured ridges 30, knobs, protrustions, indentations, knurling, or other surface features may also be present along all or a portion of the edges of the housing 12 to improve gripping of cartridge 10 by a human or robotic operator to facilitate loading and unloading of the housing 12 in the detection device 28.

FIG. 2 depicts the underside of cartridge 10. The bottom section 12b of housing 12 defines window 32. A transparent support 34 covers window 32 and provides a mounting location for an array 36, contained within the cartridge 10, as described in more detail below. Window 32 is located such that, when the cartridge 10 is inserted into detection device 28, window 32 is aligned with an optical path of a detector, for example, a charged coupled display (CCD) detector, camera or other sensor within the detection system, allowing array 36 to be imaged or read. Array 36, disposed on transparent substrate 34, can span the entire width of a window 32, located within the housing 12. As described below, conduit template 40, which can be fabricated from glass, a flexible rubber gasket, silica, polystyrene, polycarbonate, or a number of other synthetic resins, partially defines the outer walls of the various internal chambers and conduits within the housing 12.

FIGS. 3 and 4 depict exploded views of cartridge 10. As shown, the stacked components of cartridge 10 include the housing lower section 12b, shim pad 42, solid support 34 having array 36 disposed thereon, conduit template 40, housing top section 12a, well structure 18, and viewing window 24 for viewing monitor channel 52. The interior surfaces of the upper section 12a and the lower portion 12b are recessed to form interior cavities 44b, 44a that contain shim pad 42, solid support 34, and conduit template 40. As the surfaces of the solid support 34, conduit template 40, and the housing upper and lower sections 12a, 12b generally are smooth and non-porous, so that when screws 16 are tightened shim pad 42 is presses the components into sealing contact, preventing relative movement of the various parts and leakage, that could effect analysis of the sample. Shim pad 42 can be manufactured of rubber, latex, or other type of resilient or semi-resilient material, which compresses relative to prevent relative movement and leakage due to thermal expansion and contraction, surface imperfections, etc.

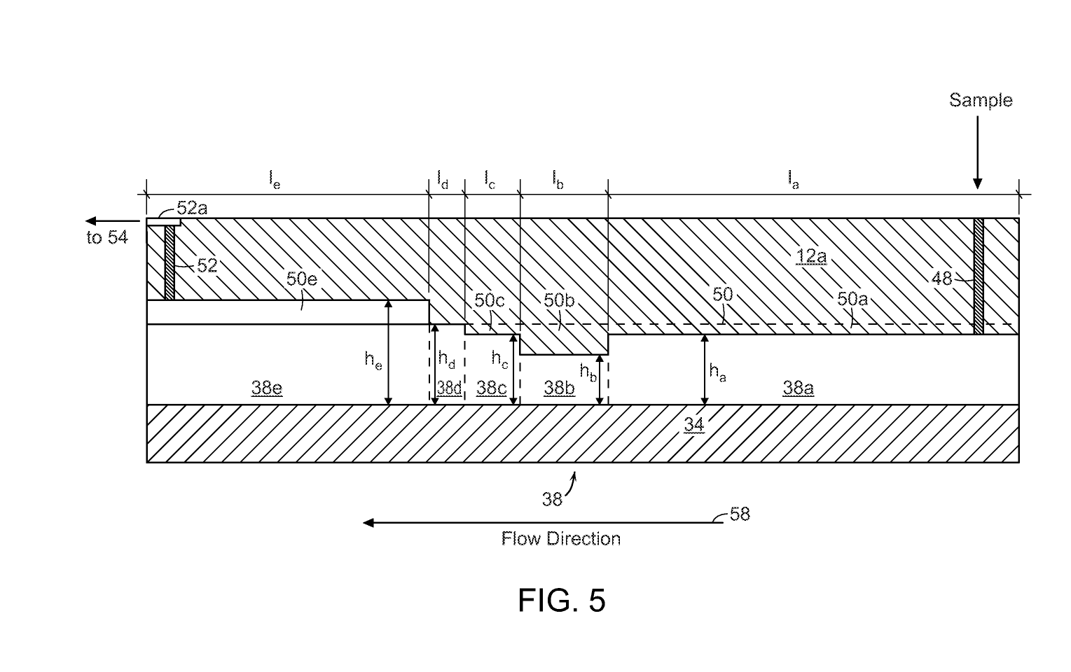

The top and bottom sections 12a, 12b of housing 12 can be constructed of, for example, a molded biocompatible material, though transparent and/or translucent glass or polymers may be desirable for certain applications. Suitable polymers include, for example, polystyrene, polycarbonate, acrylic, polyester, optical grade polymers. Alternatively, housing 12 can be manufactured of nonreactive metal or metals, including stainless steel, aluminum or titanium that are readily machined or formed into the desired dimensions. Solid support 34 can be manufactured of optically transparent glass or other polymers, as identified above with regard to the components of the housing 12. Alternatively, solid support 34 can be manufactured of opaque or translucent material, but for the portion of the substrate that defines the base of the optical cell 38b (FIG. 5). The portion of solid support 34 having the microarray disposed directly or indirectly thereon should be transparent, to allow image capture of array 36. Conduit template 40 and well structure 18 may also be manufactured of materials similar to those utilized for the housing 12.

A rubber or other compliant gasket 46 or seal may be used at the interface between well structure 18 and sample inlet 48, so as to both secure well structure 18 in place and ensure that fluid sample disposed in the well 22 is transported to conduit 38 and does not leak out into depression 20 around the well structure 18. A transparent or semi-transparent material similar to that utilized for the solid support 34 may be used for window 24 to allow an optical sensor located within detection device 28 to identify the liquid-air interface of the fluid sample being tested and to ensure that the sample is not drawn through the sample cartridge outlets 26 and into the pump or pumps of detection device 28. In use, the optical sensor can interrupt operation of the pump when it senses the leading edge of the fluid sample within the monitor channel 52a (see, FIG. 5). The presence of fluid sample at this location may indicate that the second conduit (waste conduit) 38e in housing 12 is in danger of being overfilled. Stopping the pump at this point helps prevent contamination of the pump and other components within detection device 28.

Although the width of conduit 38 is depicted as being generally constant along its length, it may be advantageous for different portions or zones of conduit 38 to have different volumes to ensure proper function. In the embodiment shown in FIGS. 1-4, the sides of the conduit 38 are substantially parallel, while the base (as formed by solid support 34) is even with the bottom of the sides of conduit 38 along its entire length. The volume of each of the different zones of the conduit 38 is largely dependent on the local height of conduit 38, from the top of the solid support 34 to the bottom surface of top section 12a. In this regard, the bottom surface 50 of the housing top section 12a defines a number of protrusions 50a-c and recesses 50e (i.e., steps) that define the local volume of the zones of the conduit 38 located immediately therebeneath. The different heights of the zones of the conduit 38 and resulting volumes of an exemplary cartridge are discussed in conjunction with FIG. 5.

FIG. 5 is a longitudinal cross-sectional view of conduit 38, showing the heights of the various defined zones. In this embodiment of cartridge 10, the walls of conduit 38 are separated a distance of about 5 mm along the entire length. In FIG. 5, a bottom surface 50 of the housing upper section 12a is represented by the dotted line. This bottom surface 50 is approximately 2 mm from the top surface of solid support (i.e., the thickness of conduit template 38 is about 0.5 mm). Sample fluid generally travels in a direction 58 from right to left in FIG. 5. The first conduit or inlet conduit 38a receives fluid from the sample inlet 48, which is a fluidic communication with the bottom of well structure 18. TABLE 1A, below depicts the physical dimensions (i.e., the length, height, width, and resulting volume) of each zone for an embodiment depicted in FIG. 5.

TABLE 1A

| Reference | | Length - lₓ | Width | Height - hₓ | Volume - vₓ |
|---|---|---|---|---|---|
| Designator | Zone Name | (mm) | (mm) | (mm) | (μL) |
| 38a | First (inlet) conduit | 30 | 4 | 1 | 120 |
| 38b | Optical cell | 12 | 4 | 0.50 | 24 |
| 38c | First transition | 4 | 4 | 0.75 | 12 |
| 38d | Second transition | 4 | 4 | 0.75 | 12 |
| 38e | Second (waste) conduit | 25 | 4 | 5 | 500 |

TABLE 1B, below depicts the physical dimensions (i.e., the length, height, width, and resulting volume) of each zone for an alternative embodiment of the cartridge depicted in FIG. 5. In this embodiment, the width of the conduit template 38 may not be consistent along its length, resulting in zones having different widths. In the embodiment depicted in TABLE 1B, the width of the optical cell 38b is narrower than the adjacent zones, while the width (and the resulting volume) of the waste conduit 38e is significantly larger than the other zones.

TABLE 1B

| Reference | | Length - lₓ | Width | Height - hₓ | Volume - vₓ |
|---|---|---|---|---|---|
| Designator | Zone Name | (mm) | (mm) | (mm) | (μL) |
| 38a | First (inlet) conduit | 30 | 4 | 1 | 120 |
| 38b | Optical cell | 12 | 3 | 0.50 | 18 |
| 38c | First transition | 4 | 4 | 0.75 | 12 |
| 38d | Second transition | 4 | 4 | 0.75 | 12 |
| 38e | Second (waste) conduit | 25 | 7 | 5 | 875 |

In general, the second (waste) conduit 38e has a volume that is at least equal to, and preferably greater than, the volume of the sample to be deposited in the well structure 18. In certain embodiments, the second (waste) conduit 38e defines volume greater than the first (inlet conduit) 38a, and/or the optical cell 38b. In certain embodiments, the waste conduit 38e, an overflow reservoir conduit 52, and an overflow reservoir 54 may be dimensioned to provide a total volume greater than or equal to the well structure 18. Other volumes of the various areas within the cartridge are contemplated depending on the particular application. Moreover, certain embodiments of cartridges may not include all of the areas defined above. For example, one or more of the transitions 38c, 38d may be eliminated. The transitions, however, help minimize hydrodynamic turbulence and, therefore, minimize bubble formation. In certain embodiments, the volume of second (waste) conduit 38e is at least 10, 15, 20, 25, 30, 35, 40, 45, 50, 55, 60, 65, 70, 75, 80, 85, 90, 95, 100, 125, 150, or 175 times the volume of optical cell 38b. It is understood that, for example, in this embodiment as well as the other embodiments described herein, the waste conduit can comprise a sorbent material to absorb the waste fluid to reduce the likelihood of the waste fluid flowing back into the optical cell, leaking out of the cartridge or sloshing within the cartridge, or a combination thereof. The sorbent material can include, for example, woven and/or randomly arranged fibers of, cellulose (for example, absorbent paper, or cellulose acetate), nylon, polyester, or glass. Exemplary absorbents includes absorbent paper made from cotton long linter fibers, such as S&S 300 or S&S 470 (available from Schleicher & Schuell, Inc.), cellulosic materials, such as Grade 3 MM (available from Whatman) or hydrophilic polyester (available from Filtrona).

As seen in FIG. 6, one or more reagents (generally denoted as 56, for example, a first reagent (for example, a detectable label) denoted as 56a and an optional second reagent (for example, a blocking agent) denoted at 56b) are preloaded into the inlet conduit 38a, generally being fixed on the solid support 34. Placement of the dried reagents within the inlet conduit 38a eliminates the need for a user to mix one or more reagents with the fluid sample prior to introduction of the sample to the well 22. This allows a user to process samples more quickly and/or use a smaller sample volume, which can be significant, if limited amounts of sample are available. Instead of mixing smaller volumes of the sample with a number of different reagents and then introducing each of these mixed samples to an assay cartridge, a plurality of cartridges containing different dried reagents can be stored and used as needed. The user need only introduce the sample to the cartridge that contains the reagents necessary for the desired test. The preloading of reagents onto a surface of the first conduit is described in more detail below. A reagent comprising a detectable label 56a is selected to bind directly or indirectly to the specific analytes that may be present in the fluid sample to be tested. Depending upon the assay format, inlet conduit 38a can further comprise an optional reagent (56b), for example, a non-specific protein, such as, bovine serum albumin (BSA), to bind excess label that has not bound to one or more analytes in the sample of interest. The reagents can span the width of the inlet conduit 38a, and may be located on either or both of the upper and lower surfaces of the conduit 38a. Accordingly, reagents may cover an area of up to about 100 mm², if located on both surfaces. Smaller areas are also contemplated. Therefore, in the direction 58 of sample flow, solid support 34 can include a first reagent 56a comprising a detectable label that binds directly or indirectly to the target analyte of interest, and then a second reagent 56b, for example, BSA, that binds excess label.

As shown in FIG. 6, a distance d₁ between the first reagent 56a and the optional second reagent 56b is about 5 mm. The distance d₂ between the second reagent 56b and the optical cell containing array 36 is about 5 mm. It is understood, however, that the actual dimensions will vary depending upon the particular assay reagents, the assay format, and the configuration of reagents to meet the assay format. Embodiments of the cartridge include array 36 areas of about 3 mm×about 3 mm, about 2 mm×about 2 mm, and about 1 mm×about 1 mm.

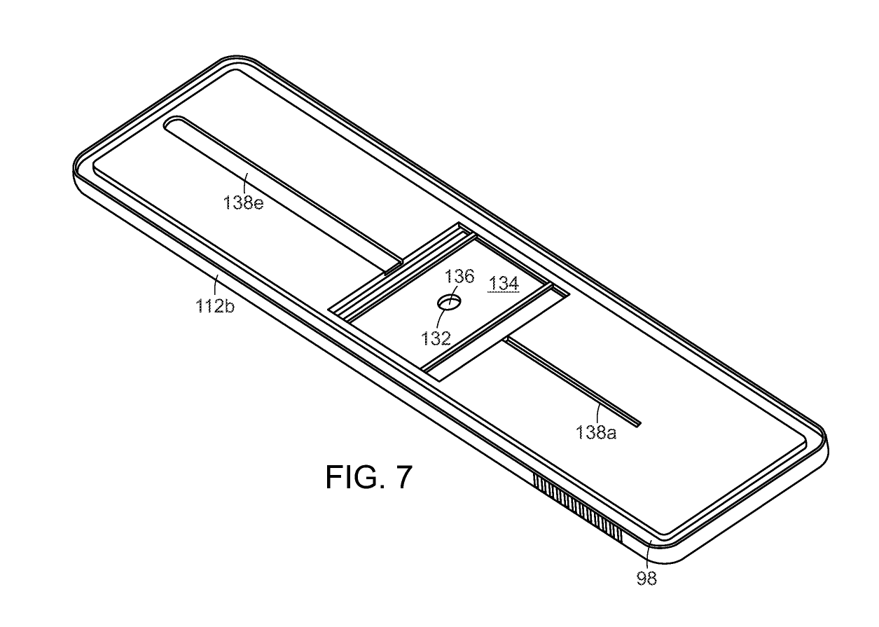

FIG. 7 depicts an alternative embodiment of a bottom section 112b of a cartridge manufactured in accordance with the invention. In this embodiment, the bottom section 112b has been machined or otherwise manufactured with a plurality of channels thereby eliminating the need for the conduit template 40 as depicted in FIGS. 3 and 4. Additionally, a clear base piece 134 is inserted into port 132 in the bottom portion 112b to support array 136. In this embodiment, the volumes of the various internal zones of the cartridge are dictated, at least in part, by the width of the individual channels. Length can also be varied. For example, assuming a consistent depth along the length of the channels, first (inlet) conduit 138a would define a smaller volume than the second (waste) conduit 138e, as waste conduit 138e is significantly wider and longer than the inlet conduit 138a. The volumes of the various zones may also be varied by projections or recesses in the top section of the housing (not shown). As shown, both the inlet conduit 138a and the waste conduit 138e are linear. In one embodiment, a flat top section joins with the bottom section 112b without such projections or recesses to simplify manufacture. A mating protrusion on the outer edge of the top section can mate with a corresponding recess 98 along the outer edge of the bottom portion 112b.

FIGS. 8A-8C depict an alternative embodiment of a cartridge 110 manufactured in accordance with the invention. Certain structural details of the cartridge 110 are described below, but any of the elements, structures, etc., described above with regard to other cartridge configurations may be utilized in the cartridge 110 as well. The cartridge 110 includes a housing 112 manufactured from of one or more sections. As depicted, housing 112 includes a top section 112a and a bottom section 112b that can be joined by mechanical features such as pins, locking tabs, or friction or press fit connections, or by chemical or material bonds such as glues, epoxies, or friction welds or other joining techniques known in the art. To reduce manufacturing costs, the top section 112a and bottom section 112b may be manufactured as injection molded components. Elements located on each section 112a, 112b (such as the fluid conduits 138, the well structure 118, etc., as described below) may be injection molded directly with the particular section 112a, 112b.

A sample well structure 118 is formed by or disposed on the top section 112a of the housing 112. In this embodiment, sample well structure 118 is integrally molded with the top section 112a of the housing 112. The well structure 118 can have a generally cylindrical outer wall 118a and frustoconical interior wall 118b that slopes downward and radially inward from the top of the outer wall 118a, thus forming a conical well 122 having a fixed volume within the well structure 118. The volume of the well 122 is dimensioned to accommodate a preselected volume of the fluid sample to be tested, and may be sized as desired for a particular application.

The well structure 118 is centered over a fluid inlet 148. Also located on the top section 112a at the end opposite the fluid inlet 148 is a plurality of outlets 126. The outlets 126 are in fluidic communication with internal conduit 138 and internal chambers disposed within the housing 112. The region of internal conduit 138 that connects fluid inlet 148 and optical cell 138b is referred to as the first conduit 138a (also referred to as the inlet conduit), and the region of internal conduit 138 that connects optical cell 138b and outlets 126 is referred to as the second conduit 138e (also referred to as the waste conduit). It is understood that the first and second conduits 138a, 138b can be defined by portions of the same structure (in the depicted embodiment, the first and second conduits are formed in the top section 112a). In general, outlets 126 are sized and configured to engage with one or more vacuum ports contained within a detection device 28 (as shown in FIG. 6). An aperture window 124 can be used by an optical detector to determine whether fluid sample is present in a monitor channel and about to contact outlets 126, which, depending upon the assay configuration, can be used to turn off the pump present in detection device 28. Indentations 130, textured ridges, knobs, protrusions, knurling, or other surface features may also be present along all or a portion of the edges of the housing 112 to improve gripping of cartridge 110 by a human or robotic operator to facilitate loading and unloading of the housing 112 in the detection device 28.

The bottom section 112b of housing 112 defines a window 132. A transparent support 134 covers window 132 and provides a mounting location for an array 136, contained within the cartridge 110, as described in more detail below. As described above with regard to other embodiments, the top and bottom sections 112a, 112b of housing 112 can be constructed of, for example, a molded biocompatible material, though transparent and/or translucent glass or polymers may be desirable for certain applications. Suitable polymers include, for example, polystyrene, polycarbonate, acrylic, polyester, optical grade polymers, etc. Alternatively, housing 112 can be manufactured of nonreactive metal or metals, including stainless steel, aluminum or titanium that are readily machined or formed into the desired dimensions. Solid support 134 can be manufactured of optically transparent glass or other polymers, as identified above with regard to the components of the housing 112. Alternatively, solid support 134 can be manufactured of opaque or translucent material, but for the portion of the substrate that defines the base of the optical cell 138b (FIG. 5). The portion of solid support 134 having the microarray disposed directly or indirectly thereon should be transparent, to allow image capture of array 136. Additionally, portions of the housing 112 may be manufactured to be transparent or substantially transparent, as desired, to allow optical detectors to detect the location of fluid inside the housing 112 during operation. These detectors, as well as their general location in the detector device 28 are described above, for example, with regard to FIGS. 1 and 6.

In the depicted embodiment, the first conduit 138a is oriented in a substantially linear or straight orientation from the inlet 148 to the optical cell 138b. This configuration allows for ease of application of the reagents (as depicted generally in FIG. 6) to the interior of the first conduit 138a. Cartridge 110 shown schematically in FIG. 8 includes an elongate second conduit 138e having substantially consistent dimensions (i.e., width and height) along its entire length. In other embodiments, the second conduit 138e can be configured in a serpentine, zig-zag, or other non-linear configuration. The elongate length of the second conduit 138e forms a waste volume larger than that of any of the well 122, the first conduit 138a, or the optical cell 138b. The consistent width and height of the second conduit 138e allow the pump in the associated device 28 to draw fluid through the conduit 138. Additionally, the total volume of the second conduit 138e reduces the likelihood that fluid contained therein will be drawn into the detection device 28, which could cause damage. As described above, the components of the cartridge 110 (for example, the array chamber 138b outlet and inlet, the fluid inlet 148, the outlets 126, the channel 138, etc.) are located substantially planar P to each other within the cartridge 110 to reduce bubble formation. This substantially planar orientation allows the cartridge 110 to be easily inserted into the detection device 28.

The total interior volume of the cartridge 110 is defined by the second conduit 138e, the optical cell 138b, and the first conduit 138a. The cartridge 110, may have a total volume (including the second conduit 138e, the optical cell 138b, and the first conduit 138a) of about 600 μL. The volume of the optical cell 138b may be between about 1 μL and about 50 μL. The volume of the first conduit 138a may be between about 50 μL and about 200 μL. The volume of the second conduit 138e may be between about 400 μL and about 550 μL. Other proportions of volumes of the second conduit 138e to the optical cell 138b and to the first conduit 138a are contemplated. In determining the volumes of the various parts of the channel 138, the total volume of the sample, wash solution(s), and any intervening air transitions may also be considered, to ensure that the waste conduit 138e will accommodate all fluids introduced to the cartridge 110, without drawing the fluids into the pump. Typical fluid volumes include a sample volume of about 50 μL, and two wash solution volumes of about 50 μL to about 200 μL. The leading and trailing surfaces of each fluid may be in contact with a trailing or leading surface of a neighboring fluid, or may be separated by a volume of about 1 μL to about 50 μL. Thus, a waste conduit of about at least 500 μL would be needed for an embodiment of the cartridge 110 into which a 50 μL sample is introduced, followed by a 25 μL air gap, a 200 μL first wash, a 25 μL air gap, and a 200 μL second gap.

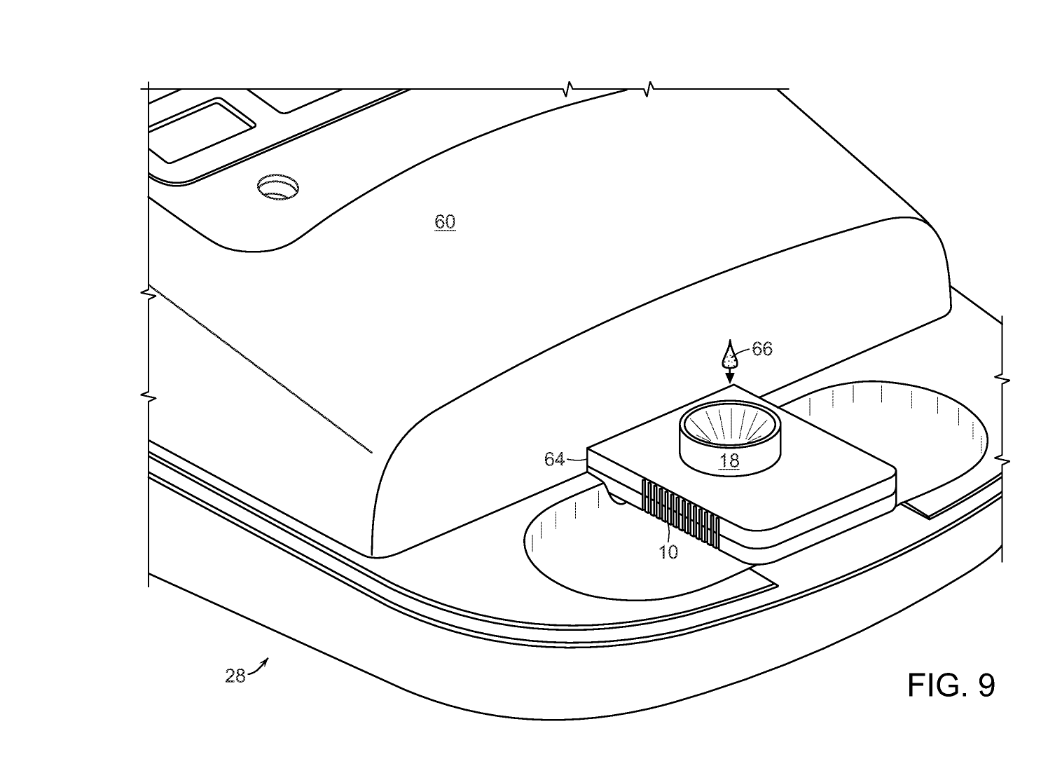

Regardless of configuration of the cartridges, when in operation, the cartridge is inserted into a suitable detection device that is operative to draw the fluid sample into the interior of the cartridge and when appropriate to image the array disposed within the cartridge. In one embodiment, as shown in FIG. 9, cartridge 10 is used in conjunction with a detection device 28 that includes a pump, at least one optical sensor, a CCD detector or other imaging device, and various control components, all contained within an outer housing. During operation, cartridge 10 is inserted into a cartridge port 64 defined by housing 60 of detection device 28. A sample 66 then is introduced to the well structure 18, by a human or robotic operator (not shown) and an automatic sample test sequence is initiated.

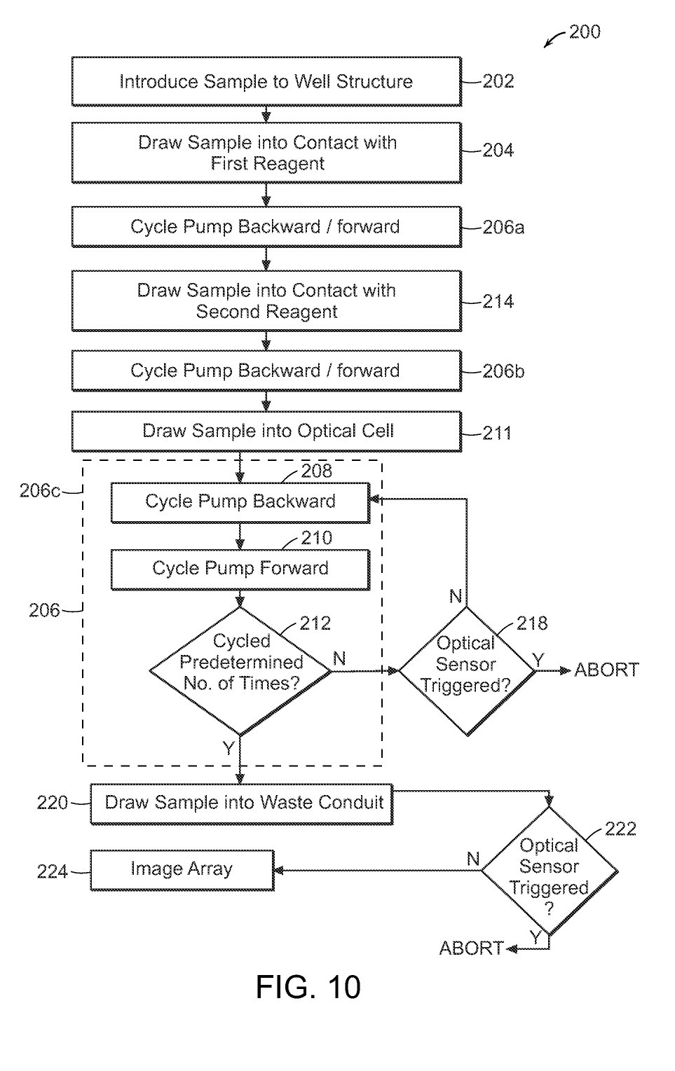

FIG. 10 is a flowchart defining an exemplary method for detecting 200 the presence of a target analyte in a fluid sample using the cartridge and testing device described herein. First, fluid sample is introduced to the well structure (step 202). The device then is activated, beginning the processing of the sample. The pump first draws the fluid sample from the well structure through the sample inlet and into the inlet conduit. The device is able to calculate the amount of sample drawn into the cartridge by measuring the displacement of the pump piston, and multiplying that value by the area of the pump cylinder to calculate a volume. The device is preprogrammed with the internal volumes of the various areas within the cartridge. Accordingly, the device is able to determine, based on the position of the pump piston, the location of the leading edge (or liquid-air interface) of the sample within the cartridge.

The pump draws the fluid sample into the cartridge until the device control determines that the sample is in contact with the first reagent (step 204). After drawing in a predetermined volume (as measured by the pump), the pump cycles backward and forward a predetermined number of cycles to dissolve or otherwise resolubilize the first reagent (step 206a). After cycling past the first reagent area, the pump then draws the sample (now having target analyte or target analytes, if present in the sample, associated with the first detection reagent) into the optional second reagent area (step 214). If no second reagent is present, the sample can pass directly to the optical cell. Again, the pump is cycled backwards and forwards as required, to dissolve or otherwise solubilize the optional second reagent (step 206b). After passing the fluid sample over the second reagent, the pump then draws the fluid sample (now containing the first reagent and the optional second reagent) into the optical cell, and into contact with the array (step 216). Again, the pump cycles backwards and forwards (step 206c) a predetermined number of times to ensure association between the labeled target analytes and the immobilized binder molecules disposed in each region of the array (step 206). For example, the pump then reverses direction, for example, by one-half step (step 208) and then moves forward, for example, by one full step, (step 210). The backward/forward cycle is repeated a predetermined number of times (step 212). The number of cycles may be based in part on the total volume of the first reagent present in the conduit. The numbers of cycles may vary as desired for a particular application. As the sample is cycled back and forth across the first reagent area, the first reagent is dissolved or otherwise solubilized in the fluid sample.

In an optional step, as the sample is drawn into the optical cell, the device can monitor a signal from the optical sensor (step 218) to ensure that the fluid sample is not drawn into the pump, which may potentially contaminate or damage the detection device. The optical sensor monitors for the presence of a liquid-air interface in the monitor channel 52a of the cartridge. If the sensor detects the presence of the liquid-air interface in the monitor channel 52a, the process may abort, causing the pump to stop functioning and causing an error message to be sent to the user. Step 218 is only depicted once the sample enters the optical cell, but it may be run at all steps during the process 200 depicted in FIG. 10, ensuring that any liquid present in the device will not be drawn into the pump. Indeed, as the optical cell is emptied by drawing the sample into the waste conduit (step 220), the optical sensor is monitored (step 222) to ensure that the sample is not drawn into the pump. A wash solution, for example, phosphate buffered saline (PBS), is introduced into the well and follows the sample into the conduit, through the optical cell, and finally into the waste conduit. This can be repeated with a second batch of wash solution. Alternatively, the optical sensor can be used to ensure that the sample is free of the optical cell prior to the device initializing the imaging sequence.

After the entire sample has been drawn from the optical cell, or under certain circumstances, when a batch of wash solution is present in the optical cell, the array is imaged (step 224). By identifying the regions in the array that produce a detectable signal, and by knowing the identity of the immobilized binder present in each of the regions of the array, it is possible to determine what analyte or analytes are present in the fluid sample. Furthermore, using the cartridges of the invention it is possible to determine the concentration of the analyte in the fluid sample. This is accomplished by quantifying the amount of label bound in a region of the array.

The method described above may be utilized with any of the cartridge configurations described herein. Due to the dimensions of the channels described with regard to FIGS. 5 and 6, however, cycling the sample occasionally may prove difficult. Under certain conditions, once the liquid is drawn a certain travel distance down the channel, the device may be unable to reverse the direction of fluid flow. This may be caused by fluid viscosity issues that are pronounced in channels having such small cross-sectional areas, or by the cross-sectional area differential between the narrow sample channel and the more expansive waste channel.

To obviate this occasional condition, the elongate fluid channel having height and width dimensions similar to that of the inlet channel, as depicted in FIGS. 8A and 8B, was developed. This design eliminates the abrupt transitions between the different channel sections by keeping the dimensions similar throughout the entire cartridge 110. The larger waste area is achieved by a longer, circuitous channel structure. While the fluid sample may be cycled within the channels of this cartridge as well, other methods may also be utilized to ensure sufficient solubilization of reagents, as well as to ensure association between the labeled target analytes and the immobilized binder molecules in the array. One such method includes drawing the fluid sample slowly through the entire channel without cycling the fluid, as described above. Each pump step of the device 28 may be about 0.5 μL. Accordingly, exemplary flow rates through the channel 138 may be about 0.5 μL/s to about 20 μL/s; about 1 μL/s to about 10 μL/s; and of about 2 μL/s to about 5 μL/s.

Optical sensors may also be used at other locations along the length of the cartridge. For example, instead of calibrating the pump to the volumes in the various zones of the cartridge as described above, the bottom portion of the cartridge can be transparent, and the detection device can be configured with an optical sensor at one or more locations proximate selected reagents. In such an embodiment, the optical sensor detects when the sample has reached each area within the cartridge, and signals the controller to begin cycling of the pump.

Throughout the description, where compositions are described as having, including, or comprising specific components, it is contemplated that compositions also consist essentially of, or consist of, the recited components. Similarly, where processes are described as having, including, or comprising specific process steps, the processes also consist essentially of, or consist of, the recited processing steps. Except where indicated otherwise, the order of steps or order for performing certain actions are immaterial so long as the invention remains operable. Moreover, unless otherwise noted, two or more steps or actions may be conducted simultaneously.

### EXAMPLES

The invention is explained in more detail with reference to the following Examples, which are to be considered as illustrative and not to be construed so as to limit the scope of the invention as set forth in the appended claims.

### Example 1

A cartridge essentially as shown in FIGS. 1-6 was fabricated and used to detect the presence of microbes in a number of different environment samples harvested from ice bored from a lava conduit of a volcano.

With reference to FIG. 4, the housing was manufactured from two sections machined from aluminum. As depicted, housing 12 included an interfitting top section 12a and a bottom section 12b. The outer dimensions of the cartridge were approximately 2.5 cm×10 cm×0.5 cm. The bottom section 12b had a contoured edge 14b adapted to mate with a corresponding contoured edge 14a of one or more protrusions 14, that extended from the top section 12a. The sections 12a, 12b of housing were joined together by 4 screws 16, and a sample well structure 18 machined from aluminum was mounted disposed on the top section 12a of the housing 12. The volume of the well 22 was dimensioned to contain about 200 μL of fluid.

Also located on the top section 12a at the end opposite the sample inlet was a plurality of outlets 26, which were in fluidic communication with internal conduit 38 (see FIGS. 3 and 4) and internal chambers disposed within the housing 12. Solid support 34 was fabricated from an epoxy coated glass slide. A microarray printer was used to print a 4×4 array (element 36) of binding moieties onto the surface of solid support 34. The binding moieties used included an anti-Staphylococcus aureus antibody, an anti-E. coli antibody, Limulus anti-LPS Factor (LALF), and anti-goat IgG as a negative control. In a first location across the width of the slide, one antibody was spotted at a separate position across the slide (location 1, position 1=LALF, location 1, position =anti-E. coli antibody, location 1, position 3=anti-Staph. aureus antibody, location 1, position 4=anti-goat IgG). The same antibodies (in the same order as before) were spotted at a second location (location 2) downstream from the first location, at a third location (location 3) downstream from the second location, and at a fourth location (location 4) downstream from the third location. For example, the LALF was located in four spots in the array at locationl, position 1; location 2, position 1; location 3, position 1; and location 4, position 1. The other antibodies were spotted in the same manner to create the 4×4 array.

The residual epoxy groups on the slide were blocked incubating the slide with a solution containing 10% BSA solution for 15 minutes at room temperature. The slide then was washed three times with PBS to remove residual BSA. After drying, 20 μL of a solution of 1 mg/mL amino functionalized AlexaFluor 532 (Invitrogen) was applied to substrate 34 at region 56a and then air dried. Then 45 μL of 10% BSA and 5 μL of 1M sodium bicarbonate were mixed and applied to substrate 34 at position 56b downstream of the AlexaFluor 532. After drying, the cartridge was assembled as shown in FIG. 4, using a flexible rubber gasket 40 to define conduit 38. The halves of the cartridge were screwed together in the dark so as not to bleach the AlexaFluor 532 dye. The dimensions of the various zones within the resulting cartridge are set forth in TABLE 2.

TABLE 2

| | Length | Width | Height | Volume |
|---|---|---|---|---|
| Zone Name | (mm) | (mm) | (mm) | (μL) |
| First (Inlet) conduit | 30 | 4 | 1 | 120 |
| Optical cell | 12 | 4 | 0.50 | 24 |
| Second (waste) conduit | 25 | 4 | 5 | 500 |

Each cartridge was used in conjunction with a Portable Test System (PTS) from Charles River Endosafe, Charleston, S.C. modified to contain a CCD detector for imaging the array. A new cartridge was used for each sample to be tested.

Each environmental sample was incubated with PBS containing 1 mg/mL lysozyme (about 250 μL to 500 μL for swab samples, and about 1 mL for each liquid sample). Each sample was incubated for 30 minutes at 27° C. to 37° C., and, if necessary, spun down to remove particulate material. Then 180 μL of each sample was combined with 20 L of 1M sodium bicarbonate to increase the pH of sample. Then, 25 μL of a sample was added to the well of the cartridge placed inside the PTS system. The PTS system was operated as follows. The sample, after being added to the inlet, was draw into the conduit and into contact with the AlexaFluor 532 dye at region 56a for 30 minutes with mixing. Mixing was achieved by moving the sample backwards and forwards. Then, the sample was moved to region 56b containing the dried BSA for 15 minutes with mixing, which was again achieved by moving the sample backwards and forwards. Thereafter, the sample was drawn into the optical cell for 5 minutes, also with mixing to permit the analytes, if present, to be bound by the binding moieties immobilized in the array. After 5 minutes, the sample was moved to the waste conduit.

Thereafter, the array was washed three times. Initially, a 25 μL sample of PBS was added to the inlet and drawn to the array. The first PBS wash contacted the array for 2 minutes and then was drawn to the waste conduit. This was repeated with a second PBS wash. A third PBS wash was introduced into the optical chamber, but was present as the array was imaged with the CCD detector.

The data generated using a number of environmental samples is summarized in TABLE 3.

TABLE 3

| Sample | | Anti-E. coli | Anti-S. aureus | |
|---|---|---|---|---|
| No. | LALF | antibody | antibody | Anti-Goat IgG |
| 1 | Positive | Negative | Negative | Negative |
| 2 | Positive | Positive | Slightly | Negative |
| | | | positive | |
| 3 | Negative | Negative | Negative | Negative |
| 4 | Positive | Negative | Negative | Negative |
| 5 | Positive | Negative | Negative | Negative |
| 6 | Positive | Negative | Negative | Negative |

The data set forth in TABLE 3 demonstrate that the array could detect the presence of different species of microbes from the different environmental samples. The anti-goat IgG spots remained negative demonstrating that non-specific binding was not occurring in the array.
Incorporation by Reference

The entire disclosure of each of the publications and patent documents referred to herein is incorporated by reference in its entirety for all purposes to the same extent as if each individual publication or patent publication was so individually denoted.
Equivalents

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

What is claimed is:

1. A cartridge for detecting presence of a target analyte in a fluid sample, the cartridge comprising:
a housing defining a sample inlet, an optical cell, an outlet, a first conduit in fluidic communication with the sample inlet and the optical cell, and a second conduit in fluidic communication with the outlet and the optical cell;
an addressable array disposed within the optical cell; and
a reagent dried upon a fluid contacting surface of at least one of the sample inlet and the first conduit, such that, when a fluid sample is applied to the fluid inlet, the fluid sample mobilizes and transports the reagent to the optical cell.

2. The cartridge of claim 1, wherein the dried reagent comprises a detectable label.

3. The cartridge of claim 2, wherein the dried reagent comprises a chemical moiety capable of chemically coupling the detectable label to the target analyte.

4. The cartridge of claim 1, wherein the dried reagent comprises a binder for the analyte.

5. The cartridge of claim 4, wherein the binder for the analyte is associated with a detectable label.

6. The cartridge of any one of claims 1, wherein the second conduit defines a first volume.

7. The cartridge of claim 6, wherein the sample inlet defines a sample well.

8. The cartridge of claim 7, wherein the sample well defines a second volume, wherein the first volume is greater than the second volume.

9. The cartridge of claim 6, wherein the optical cell defines a third volume, wherein the first volume is greater than the third volume.

10. The cartridge of any one of claims 1, wherein the cartridge further comprises a second reagent dried on a fluid contacting surface of the inlet conduit at a location downstream of the first reagent, such that fluid sample contacts the first reagent before contacting the second reagent.

11. The cartridge of claim 10, wherein the second reagent is capable of binding the first reagent.

12. The cartridge of any one of claims 1, wherein the outlet is adapted to cooperate with a pump external to the cartridge.

13. The cartridge of any one of claims 1, wherein the array comprises a plurality of spaced apart regions.

14. The cartridge of claim 13, wherein each region comprises an immobilized binder for an analyte.

15. The cartridge of claim 14, wherein each region comprises plurality of immobilized binders, wherein each binder binds a preselected analyte.

16. The cartridge of claim 14, wherein a first binder immobilized in a first region binds a first preselected analyte and a second binder immobilized in a second region binds a second, different preselected analyte.

17. The cartridge of any one of claims 13, wherein the array comprises at least 5 regions, each of which is capable of binding a separate analyte.

18. The cartridge of claim 17, wherein the array comprises at least 10 regions, each of which is capable of binding a separate analyte.

19. The cartridge of claim 18, wherein the array comprises at least 50 regions, each of which is capable of binding a separate analyte.

20. The cartridge of any one of claims 1, wherein the array is disposed upon a base of the optical cell.

21. The cartridge of claim 20, wherein the array is disposed directly on the base of the optical cell.

22. The cartridge of claim 21, wherein the array is disposed upon a solid support separate from the base of the optical cell.

23. The cartridge of any one of claims 1, wherein at least a portion of the optical cell is substantially transparent.

24. The cartridge of any one of claims 1, wherein the sample inlet is defined at least in part by an upper portion of the cartridge.

25. A method of detecting presence of a target analyte in a fluid sample, the method comprising the steps of:
(a) applying a fluid sample to the sample inlet of the cartridge of any one of claims 1; and
(b) detecting the presence of a signal produced at the addressable array, wherein the presence of signal is indicative of the presence of a preselected analyte in the sample.

26. The method of claim 25, wherein a plurality of signals are detected at different locations of the array, and wherein each signal is indicative of the presence of different analytes in the fluid sample.
